(19) United States
(12) Patent Application Publication
(10) Pub. No.: US 2024/0026948 A1
(43) Pub. Date: Jan. 25, 2024

(54) APPARATUS FOR PROTECTING A HANDHELD DEVICE USING A SPRING BASED MECHANISM

(71) Applicant: Preeyarika Innovations Private Limited, Mumbai (IN)

(72) Inventor: Niharika Gupta, Mumbai (IN)

(21) Appl. No.: 18/227,856

(22) Filed: Jul. 28, 2023

(30) Foreign Application Priority Data
Jul. 22, 2022 (IN) 202221043372

(51) Int. Cl. F16F 13/00; A45C 11/00

(52) U.S. Cl. CPC F16F 13/00; A45C 11/00; A45C 2011/002; F16F 2230/0023; F16F 2230/0047; F16F 2230/08

(57) ABSTRACT

An apparatus for protecting a handheld device using a spring-based mechanism is described. The apparatus includes one or more protection means, an actuation unit and at least one sensor. The actuation unit includes a plurality of actuating elements, a spring, a loading element and a damper coupled to the spring. The plurality of actuating elements is configured to actuate the actuation unit to unfold the spring and push the damper coupled to the spring in the direction of the protection means to slide the protection means from the stowed position to the deployed position when the sensor detects the dropping event.

### TECHNICAL FIELD

The present invention relates generally to protective casings for handheld devices and more particularly relates to an apparatus for protecting the handheld device.

### BACKGROUND

In today's world, handheld devices are very popular and their usage is wide spread. A handheld device can be a mobile device, a tablet, a palm laptop, a remote-control device, or any similar electronic device. The handheld devices work on myriad of delicate and expensive components. In day-to-day handling of the handheld devices, there are chances that the handheld device may drop or fall from the substantial height, thereby damaging the handheld device. It is important to protect the handheld devices as the impact causes damage to the delicate components of the handheld devices, thereby completely or partially disabling the functionality. In some instances, there are high chances that the handheld devices are permanently damaged.

In the prior art, various types of covers are available with various materials and designs. Also flip covers are widely used for protecting touch screen of handheld devices. Typically, a plastic or leather cover is used to protect/wrap the handheld device, but the cover protects only the screen of the handheld device. Inner delicate components may be damaged because of the impact of the force generated due to the sudden falling event. Back covers are available to take care of the handheld device during dropping event. However, in a severe dropping event of the handheld device, these conventional back covers cannot sustain the generated impact force during the dropping event, thereby causing damage to the inner fragile components of the handheld device. Further, these conventional back covers create technical problems in the handheld device due to heat dissipation, thereby heating the handheld device even for a short duration usage. Also, heat dissipation causes impact on charging speed of the handheld device. The handheld devices with the conventional back covers consume more power for good signal strength. Installation of covers such as screen protectors is complicated and these covers cannot be reused.

### SUMMARY

Embodiments of the present disclosure present technological improvements as solutions to one or more of the above-mentioned technical problems.

Before the present subject matter relating to an apparatus for protecting a handheld device using a spring based mechanism, it is to be understood that this application is not limited to the particular apparatus described, as there can be multiple possible embodiments which are not expressly illustrated in the present disclosure. It is also to be understood that the terminology used in the description is for the purpose of describing the implementations or versions or embodiments only and is not intended to limit the scope of the present subject matter.

This summary is provided to introduce aspects related to an apparatus for protecting a handheld device using a spring based mechanism. This summary is not intended to identify essential features of the claimed subject matter nor is it intended for use in determining or limiting the scope of the present subject matter.

In one embodiment, an apparatus for protecting a handheld device using a spring based mechanism is disclosed. In one embodiment, the apparatus includes one or more protection means disposed inside a housing. The one or more protection means are configured to slide from a stowed position inside the housing to a deployed position out of the housing. An actuation unit is coupled to the one or more protection means. The actuation unit includes a plurality of actuating elements, a spring, a damper coupled to the spring and a loading element. At least one sensor is coupled to the actuation unit. The at least one sensor is configured to detect a dropping event of the handheld device. The plurality of actuating elements is configured to actuate the actuation unit to unfold the spring and push the damper coupled to the spring in the direction of the protection means to slide the protection means from the stowed position to the deployed position when the sensor detects the dropping event.

### BRIEF DESCRIPTION OF THE ACCOMPANYING DRAWINGS

The foregoing detailed description of embodiments is better understood when read in conjunction with the appended drawings. For the purpose of illustrating the disclosure, there is shown in the present document example constructions of the disclosure; however, the disclosure is not limited to the specific apparatus or method disclosed in the document and the drawings.

The present disclosure is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates an elevation of a handheld device depicting an arrangement of actuating elements, in accordance with an embodiment of the present subject matter.

FIG. 2 illustrates an elevation of a handheld device depicting an arrangement of umbrellas, in accordance with an embodiment of the present subject matter.

FIG. 3 illustrates a handheld device after a severe dropping event, in accordance with an embodiment of the present subject matter.

FIG. 4 illustrates an elevation of a handheld device depicting an arrangement of a plurality of actuating elements, in accordance with an embodiment of the present subject matter.

FIG. 5 illustrates an elevation of a handheld device depicting an arrangement of umbrellas, in accordance with an embodiment of the present subject matter.

FIG. 6 illustrates a handheld device after a severe dropping event, in accordance with an embodiment of the present subject matter.

FIG. 7 illustrates a sectional view depicting an actuation unit in accordance with an embodiment of the present subject matter.

FIG. 8 illustrates a sectional view depicting an actuation unit in accordance with an embodiment of the present subject matter.

FIG. 9 illustrates a sectional view depicting an actuation unit, in accordance with an embodiment of the present subject matter.

In the above accompanying drawings, a non-underlined number relates to an item identified by a line linking the non-underlined number to the item. When a number is non-underlined and accompanied by an associated arrow, the non-underlined number is used to identify a general item at which the arrow is pointing.

Further, the figures depict various embodiments of the present subject matter for purposes of illustration only. One skilled in the art will readily recognize from the following discussion that alternative embodiments of the structures and methods illustrated herein may be employed without departing from the principles of the present subject matter described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although an apparatus for protecting a handheld device using a spring based mechanism, similar or equivalent to those described herein can be used in the practice or testing of embodiments of the present disclosure, the exemplary, an apparatus for protecting a handheld device using spring based mechanism is now described.

Various modifications to the embodiment will be readily apparent to those skilled in the art and the generic principles herein may be applied to other embodiments. For example, although the present disclosure will be described in the context of an apparatus for protecting a handheld device using a spring based mechanism, one of ordinary skill in the art will readily recognize that an apparatus can be utilized in any situation where there is a dropping of a handheld device from higher surface. Thus, the present disclosure is not intended to be limited to the embodiments illustrated but is to be accorded the widest scope consistent with the principles and features described herein.

The present disclosure provides technical solutions to the technical problems identified in the prior art. In the prior art, various types of covers are available with various materials and designs. Also, flip covers are widely used for protecting touch screen of handheld devices. The problem with these covers is that the covers protect only a touch screen of the handheld devices. In the dropping event of the handheld device, the inner fragile components may be damaged causing inoperability of the handheld device. Back covers are available to take care of the handheld device during the dropping event. However, in a severe dropping event of the handheld device, these conventional back covers cannot sustain the generated impact force during the dropping event, thereby causing damage to the inner fragile components of the handheld device. Further, these conventional back covers create technical problems in the handheld device due to heat dissipation, thereby heating the handheld device even for a short duration usage. Also, heat dissipation causes impact on charging speed of the handheld device. The handheld devices with the conventional back covers consume more power for good signal strength. Installation of covers such as screen protectors is complicated and these covers cannot be reused. Above problems and other problems should be identified by a person ordinary skilled in the art. The present disclosure provides a technical solution to the aforementioned technical problems in the prior arts. The apparatus as disclosed in the present disclosure acts as a cover for the handheld device which includes a plurality of bumpers, a plurality of umbrellas and an actuation unit. The cover can be a back cover or a flip cover of the handheld device. Bumpers are adapted to protect the handheld device when the impact force generated during the dropping event of the handheld device is less than a predetermined threshold value of the impact force. In the severe dropping event of the handheld device, when the generated impact force is greater than the predetermined threshold value, the actuation unit is automatically activated for opening up the umbrellas, thereby preventing the damage of the delicate parts of the handheld device. The apparatus, as disclosed in the present disclosure, can sustain the impact force generated during the dropping event of the handheld device, when the handheld device is encased with the apparatus, either by bumpers or by an umbrella, thereby protecting the handheld device from the damage. The bumpers and umbrellas are automatically retracted back to their original position after deploying the apparatus disclosed in the present disclosure, thereby reusing the same apparatus for the handheld device. The apparatus as disclosed in the present disclosure is installed at all sides of the handheld device for keeping the back side of the handheld device open, thereby avoiding the heat dissipation. Thus, the handheld device encased with the apparatus gets a good signal strength. Also, the handheld device does not heat up during the usage, and charging speed of the handheld device is maintained properly. The installation of the apparatus disclosed in the present disclosure is very simple.

In an embodiment, as described above, an apparatus for protecting a handheld device using a spring based mechanism is used to protect the inner fragile components of the handheld device when the handheld device falls from any object such as a table or in the event of a free fall of the handheld device from user's hand. The installation of an apparatus on the handheld device is very simple. The apparatus for protecting a handheld device includes a housing, a bumper, a sensor, an actuation unit, a one or more protection means and a locking mechanism. The housing may be of a size to receive the handheld device such as a tablet or an iPad® or a remote-control device. One or more protection means are disposed inside the housing through an openable flap provided at the corners of the apparatus. The protection means may be an umbrella or an inverted umbrella stowed inside the housing. In one embodiment, the umbrella may be a balloon shaped umbrella. The umbrella may be made up of a light material, thereby making the apparatus light weight.

The apparatus includes a bumper forming an edge of the handheld device and mounted on diagonally opposite corners of the housing. The bumper may be an openable flap. In one embodiment, the bumper may be made up of a resilient material. In one embodiment, the apparatus includes at least one sensor disposed inside the housing to detect the severe dropping event of a handheld device. The sensor detects a dropping event of a handheld device when the handheld device falls from the user's hand or from any objects. In an embodiment, the sensor includes an application specific integrated circuit (ASIC) configured to compute the rate of fall and the impact force generated during the dropping event of the handheld device. A predetermined threshold value for the impact force is computed based on the sensitivity of internal parts, and total impact force. In addition to that, another suitable factors may be employed for the computation of the predetermined threshold value. The actuation unit includes a first actuating element and a second actuating element. The first actuating element and the second actuating element are connected to the sensor. In one embodiment, the first actuating element and the second actuating element may be located on sides of the apparatus. In another embodiment, the first actuating element and the second actuating element are located at the centre of the back side of the handheld device. The actuation unit is coupled to the sensor. The actuation unit is activated by the sensor when the generated impact force is greater than the predetermined threshold value of the impact force. The bumpers may sustain the impact force generated by dropping of the handheld device, when the generated impact force is less than the predetermined threshold value of the impact force and the actuation unit remains in a deactivated state. When the impact force is greater than the predetermined threshold value, the sensor generates a signal to activate the actuation unit. The actuation unit comprises a plurality of actuating elements, a spring, a damper coupled to the spring and a loading element. During the dropping event of the handheld device encased with the apparatus, the sensor generates a signal to initiate the actuation unit. The actuation unit actuates a plurality of actuating elements to unfold the spring and push the damper coupled with spring by providing external force to one or more protection means to slide from the stowed position inside the housing to the deployed position outside the housing. The sensor generates a signal to the actuation unit for triggering a knob present on the shaft of the umbrella. The umbrella unlocks the locking mechanism and open up through an openable flap thereby pushing the bumper away from the housing. One or more umbrellas open up simultaneously/concurrently and cover the handheld device from the front side and the back side, thereby protecting the handheld device from damage during the severe dropping event. After deploying, the umbrellas are retracted back and locked into the housing. The sensor generates a signal to activate the actuation unit. The activated actuation unit initiates the plurality of actuating elements to trigger the knob for closing the umbrellas. The open up umbrellas get closed and slide from deployed position out of the housing to the stowed position inside the housing. The locking mechanism locks the umbrellas inside the housing and restores the apparatus at its original orientation.

In one embodiment, the apparatus includes a pair of magnets. Each magnet is disposed at opposite end of the spring. The pair of magnets are configured to lock the spring in the compressed state by a magnetic force between the magnets. In the dropping event of the handheld device, encased with the apparatus, the sensor generates a signal to the plurality of actuating elements, to demagnetize the magnetic field produced by the pair of magnets. Demagnetized magnetic field releases the spring in an uncompressed state, to push the damper in the direction of the one or more protection means, to slide from the stowed position inside the housing to the deployed position outside the housing.

In one embodiment, the actuation unit, the sensor and at least one protection means may be incorporated into a case which is coupled to the handheld device or any portable electronic device.

It should be noted that the above advantages and other advantages will be better evident in the subsequent description. Further, in the subsequent section the present subject is better explained with reference to the figures.

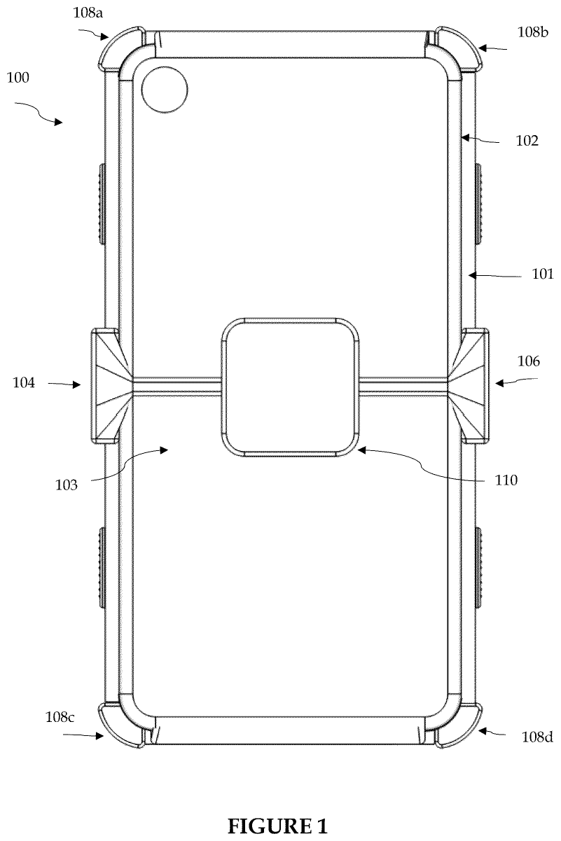

Referring now to the drawings, particularly by their reference numbers, FIG. 1 illustrates an elevation of an apparatus for protecting a handheld device, in accordance with an embodiment of the present claimed subject matter.

In an embodiment, an apparatus 100 for protecting a handheld device 102, comprises a housing 101, an actuation unit 103, a plurality of bumpers 108a, 108b, 108c, 108d and a sensor 110. The actuation unit 103 comprises a first actuating element 104 and a second actuating element 106. The first actuating element 104 is located at the centre of the first longitudinal side of the housing 101 and the second actuating element 106 is located at the centre of the second longitudinal side of the housing 101. Each bumper 108 is positioned at a corner of the housing 101 of the apparatus 100. In an embodiment, each bumper 108 is located at diagonally opposite ends of the housing 101. The bumper 108a and the bumper 108d are positioned diagonally opposite to each other. The bumper 108b and the bumper 108c are positioned diagonally opposite to each other. In one embodiment, the bumper 108 is an openable flap and is made up of a resilient material. The first actuating element 104 and the second actuating element 106 are connected to the sensor 110. The sensor 110 is configured to detect a dropping event of the handheld device 102 when the handheld device falls from the user's hand or from any object, for example, a table, and the handheld device 102 is encased with the apparatus 100. In an embodiment, the sensor 110 includes an application specific integrated circuit (ASIC) configured to compute the rate of fall and the impact force generated during dropping event of the handheld device 102 encased with the apparatus 100.

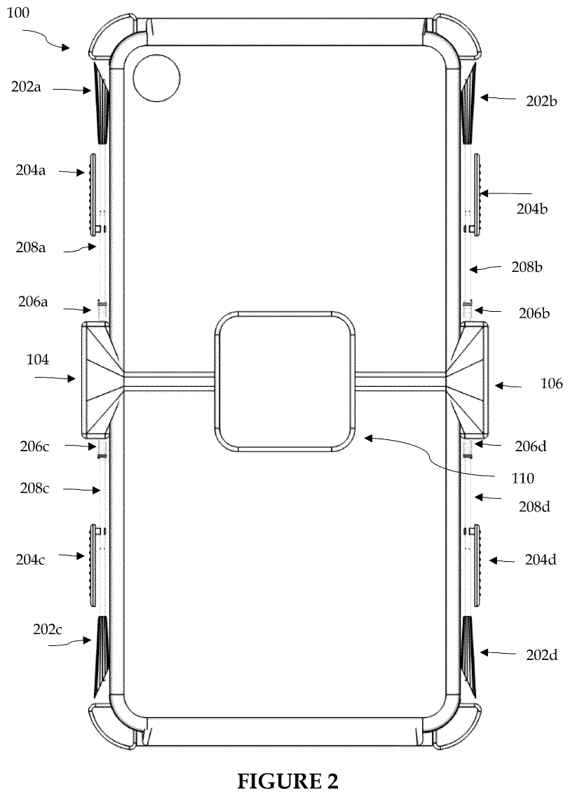

FIG. 2 illustrates a handheld device 102 along with the arrangement of one or more protection means (202a, 202b, 202c, 202d). In one embodiment, the protection means (202) are umbrellas 202a, 202b, 202c and 202d. Each umbrella 202 includes a cover, a shaft 208 with a knob 204. The umbrella 202a includes a cover and a shaft 208a with a knob 204a. The shaft 208a holds the umbrella 202a in an upward standing position. In one embodiment, the shaft 202a is made up of, but is not limited to, an aluminum, a wooden material, or a fiberglass. The shaft 208a is coupled to the first actuating element 104 via a spring 206a. The umbrella 202a is stowed inside the housing 101 at the top section of the first longitudinal side of the apparatus 100. The umbrella 202b includes a cover and a shaft 208b with a knob 204b. The shaft 208b holds the umbrella 202b in an upward standing position. In one embodiment, the shaft 208b is made up of, but is not limited to, an aluminum, a wooden material, or a fiberglass. The shaft 208b is coupled to the second actuating element 106 via a spring 206b. The umbrella 202b is stowed inside the housing 101 at the top section of second longitudinal side of the apparatus 100. The umbrella 204c includes a cover and a shaft 208c with a knob 204c. The shaft 208c is coupled to the first actuating element 104 via a spring 206c. The shaft 208c holds the umbrella 202c in a downward standing position. In one embodiment, the shaft 208c is made up of, but is not limited to an aluminum, a wooden material or a fiberglass. The umbrella 202c is stowed inside the housing 101 at the bottom section of the first longitudinal side of the apparatus 100. The umbrella 204d includes a cover and a shaft 208d with a knob 204d. The shaft 208d is coupled to the second actuating element 106 via a spring 206d. The umbrella 202d is stowed inside the housing 101 at the bottom section of second longitudinal side of the apparatus 100.

When a severe dropping event of the handheld device 102 encased with the apparatus 100 occurs, the sensor 110 determines the rate of fall and the impact force is generated due to the dropping event. If the impact force is greater than the predetermined threshold value, the sensor 110 generates a signal to activate the actuation unit 103. In an embodiment, the predetermined threshold value is an accepted threshold value. The actuating element 104 actuates the umbrella 202a to slide from the stowed position inside the housing 101 to the deployed position outside the housing 101 in the upward direction, by providing the external force via the spring 206a. The umbrella 202a pushes the bumper 108a away from the housing 101 during deployment. The deployed position may be the top corner of the first longitudinal side of the apparatus 100 outside the housing 101. The sensor 110 generates a signal to trigger the knob 204a present on the shaft 208a thereby opening the umbrella 202a outside the housing 101. Similarly, the actuating element 104 actuates an inverted umbrella 202c to slide from the stowed position inside the housing 101 to the deployed position outside the housing 101 in the downward direction, by providing the external force via the spring 206c. The umbrella 202c pushes the bumper 108c away from the housing 101 in downward direction during deployment. The deployed position may be the bottom edge of the first longitudinal side of the apparatus 100 outside the housing 101. In an embodiment, the sensor 110 generates a signal to trigger the knob 204c present on the shaft 208c thereby opening the umbrella 202c. The actuating element 106 actuates the umbrella 202b to slide from the stowed position inside the housing 101 to the deployed position outside the housing 101 in upward direction, by providing the external force via spring 206b. The umbrella 202b pushes the bumper 108b away from the housing 101 in the upward direction during deployment. The deployed position may be the top edge of the second longitudinal side of the apparatus 100 outside the housing 101. The sensor 110 generates a signal to trigger the knob 204b present on the shaft 208b thereby opening the umbrella 202b. Similarly, the actuating element 106 actuates the inverted umbrella 202d to slide from the stowed position inside the housing 101 to the deployed position outside the housing 101 in a downward direction during deployment. The deployed position may be the bottom edge of the second longitudinal side of the apparatus 100 outside the housing 101. The sensor 110 generates a signal to trigger the knob 204d present on the shaft 208d, thereby opening the umbrella 202d.

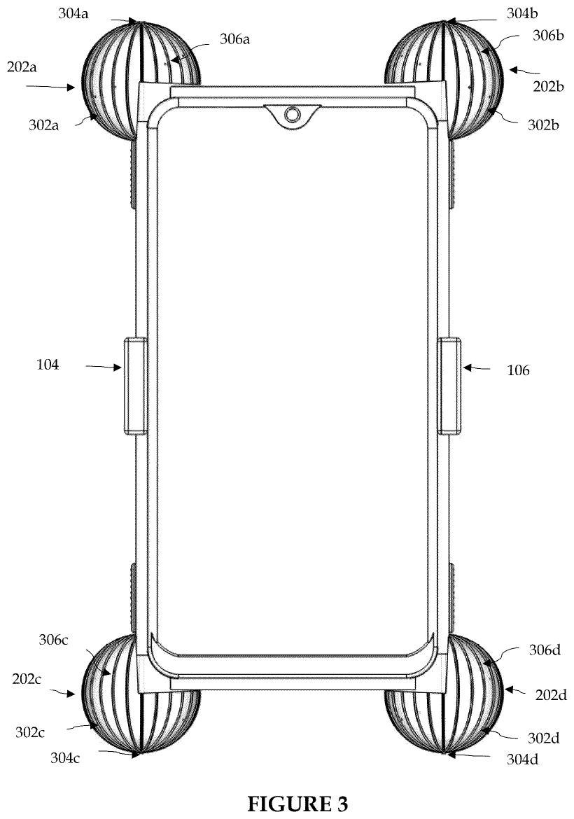

FIG. 3 illustrates a handheld device 102 encased with the apparatus 100 in a dropping event with open up umbrellas 202. The apparatus 100 includes one or more umbrellas 202 as a protection means. In one embodiment, the umbrellas 202 include a balloon shaped cover to provide the appearance of umbrella 202 as balloons. In one embodiment, the umbrellas 202a includes a balloon shaped cover, a plurality of ribs 302a, a runner, a plurality of stretchers, a shaft 208a, a top spring and a tip 304a. The tip 304a is provided at the top edge of the umbrella 202a. A balloon shaped cover is made up of a plurality of panel sections 306a. In one embodiment, the cover is made up of but is not limited to, a plurality of plastic panel sections, Teflon panel sections, and acrylic panel sections. The plurality of stretchers is coupled to the shaft 208a. The plurality of ribs 302a is attached to the shaft 208a and connected to the stretchers with a joiner. The balloon shaped cover is supported by a plurality of ribs 302a. The ribs 302a are running from the tip 304a of the umbrella 202a to the bottom edge of the umbrella 202a and provide a framework to the balloon shaped cover of the umbrella 202a. The runner provides vertical up-down movement to the shaft 208a for opening and closing the umbrella 202a. Similarly, the umbrella 202b includes a balloon shaped cover, a plurality of ribs 302b, a runner, a plurality of stretchers, a shaft 208b, a top spring and a tip 304b. The tip 304b is provided at the top edge of the umbrella 202b. A balloon shaped cover is made up of a plurality of panel sections 306b. In one embodiment, the cover is made up of, but is not limited to, a plurality of plastic panel sections, teflon panel sections, and acrylic sections. The plurality of stretchers is coupled to the shaft 208b. The plurality of ribs 302b is attached to the shaft 208b and connected to the stretchers with a joiner. The balloon shaped cover is supported by a plurality of ribs 302b. The ribs are running from the tip 304b of the umbrella 202b to the bottom edge of the umbrella 202b and provide a framework to the balloon shaped cover of the umbrella 202b. The runner provides vertical up-down movement to the shaft 208b for opening and closing the umbrella 202b.

In an embodiment, the umbrellas 202c and 202d can be inverted umbrellas. The umbrella 202c includes a balloon shaped cover, a plurality of ribs 302c, a runner, a plurality of stretchers, a shaft 208c, a top spring and a tip 304c. The tip 304c is provided at the top edge of the umbrella 202c such that tip 304c is in opposite direction with respect to the tip 304a of the umbrella 202a. A balloon shaped cover is made up of a plurality of panel sections 306c. In one embodiment, the cover is made up of, but is not limited to, a plurality of plastic panel sections, teflon panel sections, and acrylic sections. The plurality of stretchers is coupled to the shaft 208c. The plurality of stretchers is coupled to the shaft 208c. The plurality of ribs 302c is attached to the shaft 208c and coupled to the stretchers with a joiner. The balloon shaped cover is supported by a plurality of ribs 302c. The ribs 302c are running from the tip 304c of the umbrella 202c to the bottom edge of the umbrella 202c and provide a framework to the balloon shaped cover of the umbrella 202c. The runner provides vertical up-down movement to the shaft 208c for opening and closing the umbrella 202c. Similarly, the umbrella 202d includes a balloon shaped cover, a plurality of ribs 302d, a runner, a plurality of stretchers, a shaft 208d, a top spring and a tip 304d. The tip 304d is provided at the top edge of the umbrella 202d such that tip 304d is in opposite direction with respect to the tip 304b of the umbrella 202b. A balloon shaped cover is made up of a plurality of panel sections 306d. The plurality of stretchers is coupled to the shaft 208d. The plurality of ribs 302d is attached to the shaft 208d and connected to the stretchers with a joiner. The balloon shaped cover is supported by a plurality of ribs 302d. The ribs 302d are running from the tip 304d of the umbrella 202d to the bottom edge of the umbrella 202d and provide a framework to the balloon shaped cover of the umbrella 202d. The runner provides vertical up-down movement to the shaft 208d for opening and closing the umbrella 202d.

In the dropping event of the handheld device 102 encased with the apparatus 100, the sensor 110 generates a signal and provides the generated signal to the actuation unit 103 to trigger the knob 204a. The knob 204a slides the runner to the top portion of the shaft 208a of the umbrella 202a thereby expanding the stretchers in an outward direction. As the stretchers get expanded in the outward direction, the ribs 302a are raised up and spreads the material of the balloon shaped cover. The umbrella 202a opens up outwardly in a balloon shape at the top edge of the first longitudinal side of the apparatus 100. The top spring locks the umbrella 202a in an expanded form. The umbrella 202a opens up in a vertically upward position. Similarly, the sensor 110 generates a signal and provides the generated signal to the actuation unit 103 to trigger the knob 204b. The knob 204b slides the runner to the top of the umbrella 202b thereby expanding the stretchers in outward direction. As the stretcher gets expanded in the outward direction, the ribs 302b are raised up and spread the material of the balloon shaped cover. The umbrella 202b opens up outwardly in a balloon shape at the top edge of the second longitudinal side of the apparatus 100. The top spring locks the umbrella 202b in an expanded form. The umbrella 202b opens up in a vertically upward position.

At the same time, the sensor 110 generates a signal and provides the generated signal to the actuation unit 103 to trigger the knob 204c. The sensor 110 generates a signal to the actuation unit 103 to trigger the knob 204c. The knob 204c slides the runner to the top portion of the umbrella 202c in the downward direction thereby expanding the stretchers in the outward direction. As the stretcher gets expanded in the outward direction, the ribs 302c are raised up and spread the material of the balloon shaped cover. The umbrella 202c opens up outwardly in a balloon shape at the bottom edge of the first longitudinal side of the apparatus 100. The top spring locks the umbrella 202c in an expanded form. The umbrella 202c opens up in a vertically downward position. Similarly, the sensor 110 generates a signal and provides the generated signal to the actuation unit 103 to trigger the knob 204d. The knob 204d slides the runner to the top portion of the umbrella 202d in the downward direction thereby expanding the stretchers in outward direction. As the stretchers gets expanded in outward direction, the ribs 302d are raised up and spreads the material of the balloon shaped cover. The umbrella 202d opens up outwardly in a balloon shape at the bottom edge of the second longitudinal side of the apparatus 100. The top spring locks the umbrella 202d in the expanded form. The umbrella 202d opens up in a vertically downward position.

In the dropping event of the handheld device 102 encased with the apparatus 100, the sensor 110 generates a signal to actuate the actuation unit 103, thus the first actuating element 104 and the second actuating element 106 activates simultaneously. Therefore, one or more umbrellas 202 open up simultaneously in a balloon shape and cover front as well as back surface of the handheld device 102, thereby protecting the handheld device 102 from damage.

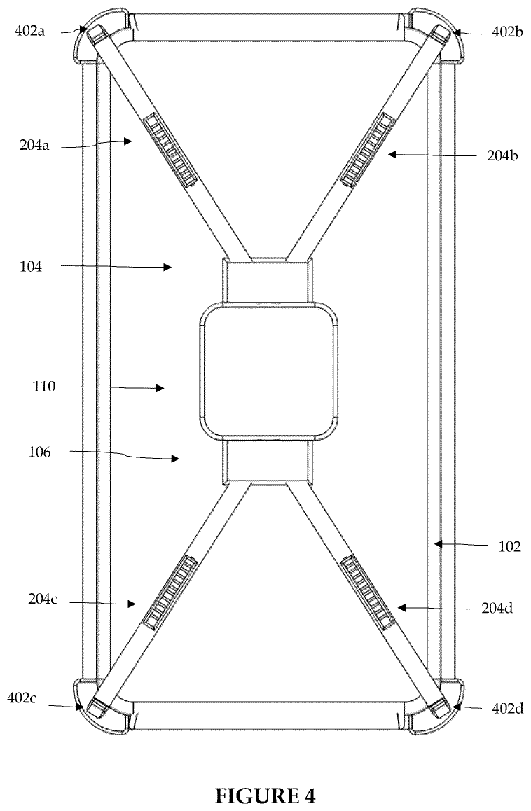

FIG. 4 illustrates the handheld device 102 encased with the apparatus 100 along with the plurality of actuating elements provided at the center of the back side of the handheld device 102. The first actuating element 104 is connected to the sensor 110 and located at the top side of the sensor 110. The second actuating element 106 is connected to the sensor 110 and located at the bottom side of the sensor 110. A locking mechanism 402a is provided at the top edge of the first longitudinal side inside the bumper 108a to lock the umbrella 202a in a stowed position inside the housing 101. A locking mechanism 402b is provided at the top edge of the second longitudinal side inside the bumper 108b to lock the umbrella 202b in a stowed position inside the housing 101. A locking mechanism 402c is provided at the bottom edge of the first longitudinal side inside the bumper 108c to lock the umbrella 202c in a stowed position inside the housing 101. A locking mechanism 402d is provided at the bottom edge of the second longitudinal side inside the bumper 108d to lock the umbrella 202d in a stowed position inside the housing 101.

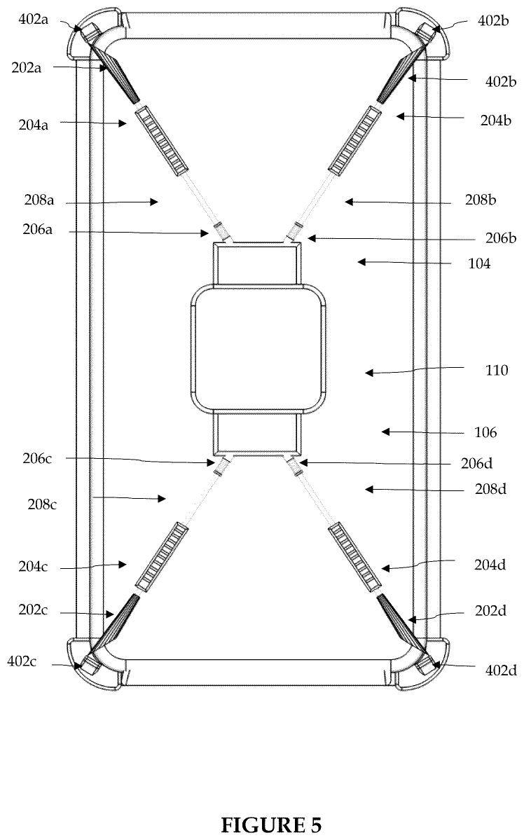

FIG. 5 illustrates a handheld device 102 encased with the apparatus 100 along with the arrangement of the protection means 202. The apparatus 100 includes inverted umbrellas 202a, 202b, 202c and 202d. The umbrella 202a is stowed inside the housing 101 at the top section of the first longitudinal side diagonally inside the housing 101. The umbrella 202a is stowed in idle position by locking in a locking mechanism 402a. The umbrella 202a includes a shaft 208a coupled to a canopy and diagonally connected to the first actuating element 104 via the spring 206a. The shaft 208a holds the umbrella 202a in a diagonal position facing the umbrella 202a in the upward direction. The shaft 208a includes a knob 204a. In one embodiment, the shaft 208a is made up of a rigid material. The umbrella 202b is stowed diagonally inside the housing 101 at the top section of second longitudinal side. The umbrella 202b is stowed in position by locking in the locking mechanism 402b. The shaft 208b holds the umbrella 202b in the diagonal position facing the umbrella 202b in diagonally upward direction. The umbrella 202b includes a shaft 208b coupled to the canopy and diagonally connected to the second actuating element 106 via the spring 206b. The shaft 208b includes the knob 204b.

The umbrella 202c is stowed inside the housing 101 at the bottom section of the first longitudinal side diagonally inside the housing 101. The umbrella 202c is stowed in the idle position by locking in the locking mechanism 402c. The umbrella 202c includes a shaft 208c coupled to the canopy and diagonally connected to the first actuating element 104 via the spring 206c. The shaft 208c holds the umbrella 202c in the diagonal position facing the umbrella 202c in the downward direction. The shaft 208c includes the knob 204c. In one embodiment, the shaft 208c is made up of a wooden material. The umbrella 202d is stowed diagonally inside the housing 101 at the top section of the second longitudinal side. The umbrella 202d is stowed in position by locking in the locking mechanism 402d. The shaft 208d holds the umbrella 202d in the diagonal position facing the umbrella 202d in diagonally downward direction. The umbrella 202d includes the shaft 208d coupled to the canopy and diagonally connected to the second actuating element 106 via the spring 206d. The shaft 208d includes the knob 204d.

When a dropping event of the handheld device 102 encased with the apparatus 100 occurs, the sensor 110 determines the rate of fall and the impact force generated due to the dropping event. If the impact force is greater than the predetermined threshold value, the sensor 110 generates a signal to activate the actuation unit 103. The first actuating element 104 actuates the umbrella 202a to slide from the stowed position inside the housing 101 to the deployed position outside the housing 101 in a diagonally upward direction, by providing an external force via a spring 206a. The umbrella 202a pushes the bumper 108a away from the housing 101 during deployment. The deployed position may be the top corner of the first longitudinal side of the apparatus 100 outside the housing 101. The sensor 110 generates a signal to actuate the first actuating element 104 for triggering the knob 204a which is present on the shaft 208a. The umbrella 202a unlocks the locking mechanism 402a and opens up outside the housing 101 in a diagonally upward direction. Similarly, the first actuating element 104 actuates the umbrella 202b to slide from the stowed position inside the housing 101 to the deployed position outside the housing 101 in the diagonally upward direction, by providing the external force via the spring 206b. The umbrella 202b pushes the bumper 108b away from the housing 101 during deployment. The deployed position may be the top corner of the first longitudinal side of the apparatus 100 outside the housing 101. The sensor 110 generates a signal to the first actuating element 104 for triggering the knob 204b which is present on the shaft 208b. The umbrella 202b unlocks the lock from the locking mechanism 402b and opens up outside the housing 101 in the diagonally upward direction.

In a dropping event of the handheld device 102 encased with the apparatus 100, the sensor 110 generates a signal to enable the actuation unit 103. The first actuating element 104 actuates the umbrella 202c to slide from the stowed position inside the housing 101 to the deployed position outside the housing 101 in the downward direction, by providing the external force via a spring 206c. The umbrella 202c pushes the bumper 108a away from the housing 101 in the downward direction during deployment. The deployed position may be the bottom edge of the first longitudinal side of the apparatus 100 outside the housing 101. The sensor 110 generates a signal to trigger the knob 204c present on the shaft 208c to open up the umbrella 202c. Similarly, the second actuating element 106 actuates the umbrella 202d to slide from the stowed position inside the housing 101 to the deployed position outside the housing 101 in the downward direction, by providing the external force via a spring 206d. The umbrella 202d pushes the bumper 108d away from the housing 101 during deployment. The deployed position may be the bottom edge of the first longitudinal side of the apparatus 100 outside the housing 101. The sensor 110 generates a signal to trigger the knob 204d present on the shaft 208d to open up the umbrella 202d in the downward diagonal direction.

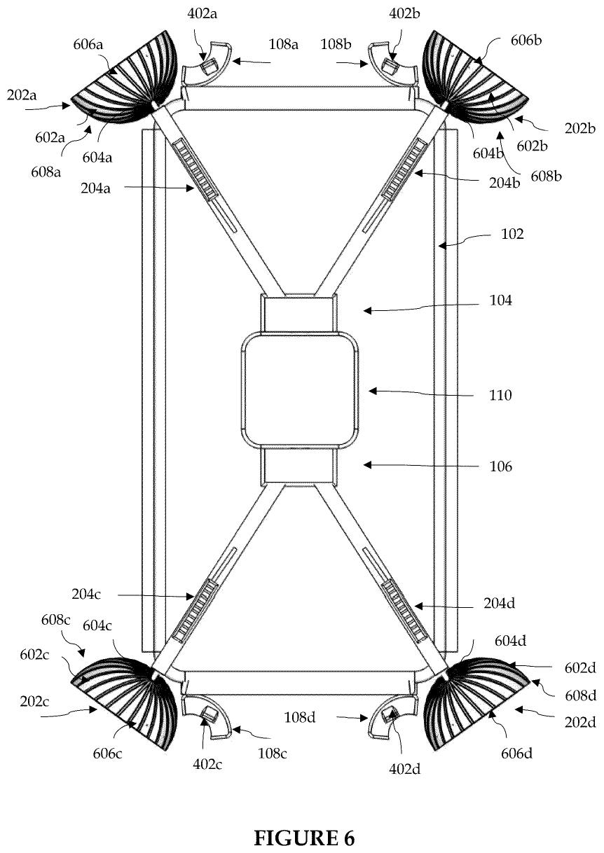

FIG. 6 illustrates a handheld device 102 encased with the apparatus 100 in a severe dropping event with open up umbrellas 202. The apparatus 100 includes one or more umbrellas 202 as a protection means. The umbrellas 202a, 202b, 202c and 202d are inverted umbrellas. In one embodiment, the umbrella 202a includes a canopy 608a, a cover, a plurality of ribs 602a, a runner, a plurality of stretchers, a shaft 208a, a top spring and a tip 604a. The tip 604a is provided at the bottom edge of the umbrella 202a. The canopy 608a is made up of a plurality of panel sections 606a. In one embodiment, the panel sections 606a are made up of a special carbon fiber material. The plurality of stretchers is coupled to the shaft 208a at the tip 604a. The plurality of ribs 602a is coupled to the stretchers via a joiner. The canopy 608a is supported by a plurality of ribs 602a. The ribs 602a are running from the tip 604a of the umbrella 202a to the top surface of the umbrella 202a and provide a framework to the canopy 608a of the umbrella 202a. The runner moves the shaft 208a in up and down direction for opening and closing the umbrella 202a.

Similarly, the umbrella 202b includes a canopy 608b, a plurality of ribs 602b, a runner, a plurality of stretchers, a shaft 208b, a top spring and a tip 604b. The tip 604b is provided at the bottom edge of the umbrella 202b. The canopy 608b is made up of a plurality of panel sections 606b. The plurality of stretchers is coupled to the shaft 208b at the tip 604b. The plurality of ribs 602b is coupled to the stretchers via a joiner. The canopy 608b is supported by the plurality of ribs 602b. The ribs 602b are running from the tip 604b of the umbrella 202b to the top surface of the umbrella 202b and provide the framework to the canopy 608b of the umbrella 202b. The runner moves the shaft 208b in up and down direction for opening and closing the umbrella 202b. The umbrella 202c includes a canopy 608c, a plurality of ribs 602c, a runner, a plurality of stretchers, a shaft 208c, a top spring and a tip 604c. The tip 604c is provided at the bottom edge of the umbrella 202c. The canopy 608c is made up of the plurality of panel sections 606c. The plurality of stretchers is coupled to the shaft 208c at the tip 604c. The plurality of ribs 602c is coupled to the stretchers via the joiner. The canopy 608c is supported by the plurality of ribs 602c. The ribs 602c are running from the tip 604c of the umbrella 202c to the top surface of the umbrella 202c and provide the framework to the canopy 608c of the umbrella 202c. The runner moves the shaft 208c in up and down direction for opening and closing the umbrella 202c. The umbrella 202d includes a canopy 608d, a plurality of ribs 602d, a runner, a plurality of stretchers, a shaft 208d, a top spring and a tip 604d. The tip 604d is provided at the bottom edge of the umbrella 202d. The canopy 608d is made up of a plurality of panel sections 606d. The plurality of stretchers is coupled to the shaft 208d at the tip 604d. The plurality of ribs 602d is coupled to the stretchers via a joiner. The canopy 608d is supported by a plurality of ribs 602d. The ribs 602d are running from the tip 604d of the umbrella 202d to the top surface of the umbrella 202d and provide the framework to the canopy 608d of the umbrella 202d. The runner moves the shaft 208d up and down for opening and closing the umbrella 202d.

In the severe dropping event of the handheld device 102 encased with the apparatus 100, the sensor 110 generates a signal to trigger the knob 204a present on the shaft 208a. The shaft 208a is coupled to the bottom of the inverted umbrella 202a at the tip 304a. The knob 204a slides the runner towards the bottom of the umbrella 202a thereby expanding the stretchers in the outward direction. As the stretcher gets expanded in the outward direction, the ribs 302a are raised up and spreads the panel sections of the canopy 608a. The umbrella 202a opens up outwardly through the openable flap at the top edge of the first longitudinal side of the apparatus 100. The top spring locks the umbrella 202a in an expanded form. The umbrella 202a opens up in an inverted position, therefore the umbrella opens in a u-shaped structure. At the same time, the sensor 110 generates the signal and provides the generated signal to the actuation unit 103 to trigger the knob 204b. The knob 204b slides the runner towards the bottom of the umbrella 202b, thereby expanding the stretchers in the outward direction. As the stretcher gets expanded in the outward direction, the ribs 302b are raised up and spreads the panel sections of the canopy 608b. The top spring locks the umbrella 202b in the expanded form. The umbrella 202b opens up outwardly at the top edge of the second longitudinal side of the apparatus 100. The umbrella 202b is in the inverted position, therefore the umbrella opens up in a u-shaped structure.

At the same time, the sensor 110 generates a signal to the actuation unit 103 to trigger the knob 204c present on the shaft 208c. The shaft 208c is coupled to the bottom of the inverted umbrella 202c at the tip 604c. The knob 204c slides the runner towards the bottom of the umbrella 202c, thereby expanding the stretchers in the outward direction. As the stretcher gets expanded in outward direction, the ribs 602c are raised up and spreads the panel sections 606c of the canopy 608c. The umbrella 202c opens up outwardly through the openable flap at the top edge of the first longitudinal side of the apparatus 100. The umbrella 202c opens in the inverted position, appears as a u-shaped structure. The umbrella 202c opens up in the vertically downward position. At the same time, the sensor 110 generates a signal and provides the generated signal to the actuation unit 103 to trigger the knob 204d. The knob 204d slides the runner towards the bottom of the umbrella 202d, thereby expanding the stretchers in the outward direction. As the stretchers get expanded in the outward direction, the ribs 602d are raised up and spreads the panel sections 606 of the canopy 608c. The umbrella 202d opens up outwardly at the top edge of the first longitudinal side of the apparatus 100. The umbrella 202d is in the inverted position, therefore the umbrella opens up in the u-shaped structure.

In the dropping event of the handheld device 102 encased with the apparatus 100, the sensor 110 generates a signal to actuate the actuation unit 103, thus the first actuating element 104 and the second actuating element 106 activates simultaneously. Therefore, one or more inverted umbrellas 202 open up simultaneously/concurrently and cover front as well as back surface of the handheld device 102, thereby protecting the handheld device 102 from damage.

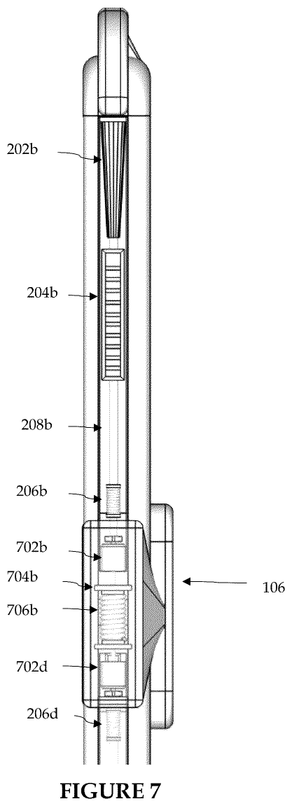

FIG. 7 illustrates the actuation unit 103 of the apparatus 100 in one embodiment. The actuation unit 103 includes a spring 706b, a damper 702b coupled to the spring 706b and a loading element 704b. The spring 706b is in compressed and locked state inside the loading element 704b. In the severe dropping event of the handheld device 102 encased with the apparatus 100, the sensor 110 generates a signal to initiate the actuation unit 103. The actuating element 106 unfolds the spring 706b, thereby pushing the damper 702b coupled to the spring 706b in an upward direction. The top spring 206b triggers the knob 204b thereby opening the umbrella 202b outside the housing 101.

In one embodiment, the apparatus 100 includes a pair of magnets 704b. Each magnet 704b is disposed at opposite end of the spring 706b. The pair of magnets 704b are configured to lock the spring 706b in the compressed state by a magnetic force between the magnets 704b. In the dropping event of the handheld device 102, encased with the apparatus 100, the sensor 110 generates a signal to the plurality of actuating elements 106, to demagnetize the magnetic field produced by the pair of magnets 704b. The demagnetized field between the pair of magnets releases the spring 706b in an uncompressed state, to push the damper 702b in the direction of the one or more protection means 202b, to slide from the stowed position inside the housing to the deployed position outside the housing.

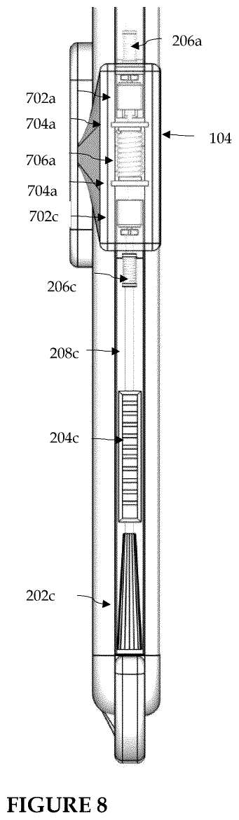

FIG. 8 illustrates the actuation unit 103 of the apparatus 100 in one embodiment. The actuation unit 103 includes a spring 706a, a damper 702c coupled to the spring 706a and a loading element 704a. The spring 706a is in compressed and locked state inside the loading element 704a. In the severe dropping event of the handheld device 102 encased with the apparatus 100, the sensor 110 generates a signal to initiate the actuation unit 103. The actuating element 106 unfolds the spring 706a, thereby pushing the damper 702c coupled to the top spring 206c in the downward direction. The spring 206c triggers the knob 204c, thereby opening the umbrella 202c outside the housing 101.

In one embodiment, the apparatus 100 includes a pair of magnets 704a. Each magnet 704a is disposed at opposite end of the spring 706a. The pair of magnets 704a are configured to lock the spring 706a in the compressed state by a magnetic force between the magnets 704a. In the dropping event of the handheld device 102, encased with the apparatus 100, the sensor 110 generates a signal to the plurality of actuating elements 104, to demagnetize the magnetic field produced by the pair of magnets 704a, to release the spring 706a in an uncompressed state, to push the damper 702c in the direction of the one or more protection means 202c, to slide from the stowed position inside the housing 101 to the deployed position outside the housing 101.

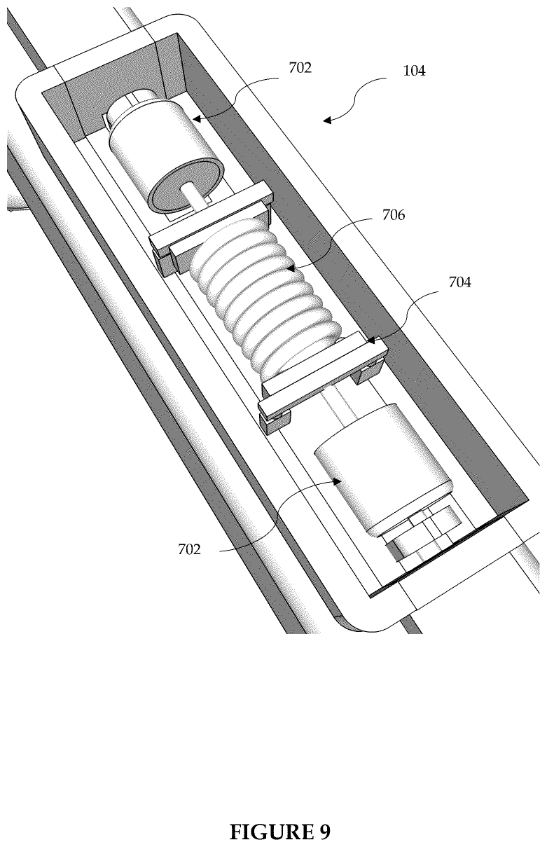

FIG. 9 illustrates a sectional view depicting the actuating element in detail. The actuating element 104 includes a spring 206, a damper coupled to the spring 702 and a loading element 704. Initially the spring 706 is in the compressed and locked state inside the loading element. In the severe dropping event of the handheld device 102 encased with the apparatus 100, the sensor generates a signal to initiate the actuation unit 103. The actuating element 104 unfolds the spring 706, thereby pushing the damper 702 coupled to the spring in an upward and a downward direction. The spring 206 coupled to the damper triggers the knob 204 located at the top surface of the apparatus 100 and the knob 204 located at the bottom surface of the apparatus thereby opening the umbrellas 202a and 202c.

Exemplary embodiments discussed above may provide certain advantages. Though not required to practice aspects of the disclosure, these following advantages may include.

Some embodiments of the apparatus provide protection to the handheld device in the severe dropping event.

Some embodiments provide a light weight apparatus for protection of a handheld device from damage during a severe dropping event.

The apparatus as disclosed in the present disclosure protects the important parts inside the handheld device, thereby improving the life of the handheld device.

Some embodiments provide an apparatus which is simple to install on a handheld device.

Although the description provides implementations of an apparatus for protecting a handheld device, it is to be understood that the above descriptions are not necessarily limited to the specific features or methods of apparatus. Rather, the specific features and methods are disclosed as examples of implementations for the apparatus for protecting a handheld device.

We claim:

1. An apparatus for protecting a handheld device, the apparatus comprising:
a one or more protection means disposed inside a housing, wherein the one or more protection means (is configured to slide from a stowed position inside the housing to a deployed position out of the housing;
an actuation unit coupled to the one or more protection means, the actuation unit comprises a plurality of actuating elements, a spring, a damper coupled to the spring, and a loading element; and
at least one sensor coupled to the actuation unit, the at least one sensor configured to detect a dropping event of the handheld device,
wherein the plurality of actuating elements is configured to actuate the actuation unit to unfold the spring and push the damper coupled to the spring in the direction of the protection means to slide the protection means from the stowed position to the deployed position when the sensor detects the dropping event.

2. The apparatus as claimed in claim 1, comprises a pair of magnets, wherein each magnet is disposed at opposite ends of the spring and configured to lock the spring in a compressed state by a magnetic force between the magnets.

3. The apparatus as claimed in claim 2, wherein the magnets are configured to demagnetize the magnetic field to release the spring in an uncompressed state to push the damper in the direction of the protection means for sliding from the stowed position inside the housing to the deployed position outside the housing, and trigger a knob present on the shaft of the protection means.

4. The apparatus as claimed in claim 1, wherein the at least one protection means is positioned at least partially around at least sides or to opposite corners of the handheld device.

5. The apparatus as claimed in claim 1, wherein the at least one protection means is spring biased toward the stowed position.

6. The apparatus as claimed in claim 1, comprising a bumper configured to form an edge of the handheld device and mount on an opening end of the housing.

7. The apparatus as claimed in claim 6, wherein the one or more protection means are configured to push the bumper away from the housing during deployment of the apparatus.

8. The apparatus as claimed in claim 1, wherein the bumper is formed of a resilient material.

9. The apparatus as claimed in claim 1, wherein the protection means are configured to be retracted back and locked into the housing during the dropping event of the handheld device.

10. The apparatus as claimed in claim 1, wherein the protection means is an umbrella and an inverted umbrella.

11. The apparatus as claimed in claim 1, wherein the at least one protection means is incorporated into at least one case that couples to the handheld device, and wherein the at least one sensor is incorporated into the at least one case.

12. The apparatus as claimed in claim 1, wherein the at least one sensor is configured to detect the dropping event by determining excess of impact force than a predetermined limit.

13. The apparatus as claimed in claim 1, wherein the impact force is measured by the at least one sensor based on kinetic energy generated during the dropping event and a distance at which the handheld device is dropped.

14. The apparatus as claimed in claim 1, wherein the at least one sensor is a strain gauge, an impact force measurement sensor or a force sensor.
